(19) United States
(12) Patent Application Publication
(10) Pub. No.: US 2005/0125456 A1
(43) Pub. Date: Jun. 9, 2005

(54) File migration method based on access history

(76) Inventors: Junichi Hara, Yokohama (JP); Koji Sonoda, Sagamihara (JP); Masaaki Iwasaki, Tachikawa (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/785,995

(22) Filed: Feb. 26, 2004

(30) Foreign Application Priority Data
Dec. 9, 2003 (JP) 2003-410618(P)

(51) Int. Cl. G06F 7/00

(52) U.S. Cl. 707/200

(57) ABSTRACT

The object of the present invention is to improve an access efficiency in a distributed environment. When a user “foo” access a file “file_1a” stored in a storage node SN1 under the control of a control node CN1 from a client CLN3 via a control node CN3 as shown by the solid lien arrow in the figure, a record of the access is accumulated in an access history of the control node CN1. If the control node CN1 refers to the access history and detects the frequent accesses from the control node CN3, it replicates or migrates the file “file_1a” to a storage node SN3 controlled by the control node CN3 as shown by the bold line arrow. The replication is performed if another device has accessed the file. Otherwise the migration is performed.

### BACKGROUND OF THE INVENTION

The present invention relates to a method of managing an information resource stored in a storage device.

Conventionally, in an environment where a plurality of storage devices are connected with a network, a technique is widely used that improves the access efficiency by migrating an information resource among the storage devices with taking into account the frequency of accesses to the information resource stored in the storage device, the performance of each storage device, the cost, and the like. Such technique includes, for example, migrating the frequently accessed information resource to the storage device with lower operating rate or to the storage device with higher performance.

Recently, a widely distributed environment is spreading that connects a plurality of networks via a wide area network, such as the Internet, to share resources, such as files. Therefore, it is also desired to improve the access efficiency through the migration/replication of information resource under such environment.

The above-mentioned technique includes, for example, the “auto-store” supplied by ARKIVIO Inc., which is shown in URL: http://arkivio.com/Arkivio_{—}4_Pg_Final_{—}3_{—}2.pdf (searched on Dec. 2, 2003).

### SUMMARY OF THE INVENTION

However, it is assumed the above-mentioned conventional technique is applied to a local area network (LAN), and therefore the technique does not take into account the difference in access speed due to the difference in network distance from a client. Accordingly, when the frequently accessed information resource is migrated to the storage device with lower operating rate or the storage device with higher performance, the network distance may be increased between such information resource and the client having frequently accessed it, and thereby deteriorating the access efficiency.

In order to solve such problems, the present invention is intended to provide a technique for performing the migration and replication of information resource, based on an access history including access frequency and information for identifying an accessor in the widely distributed environment, and thereby improving the access efficiency.

In order to solve at least part of the above problems, the present invention is configured as a first configuration described in the following. The first configuration is characterized in that a plurality of storage devices and a plurality of information resource management devices connected with a network, the information resource management devices each being provided in associated with a storage device and managing an information resource stored in the storage device, the information resource management device including: a storage information management unit for managing storage information that indicate which storage device stores the information resource in associated with identification information assigned based on identity of content of the information resource; a sending unit for sending the information resource back to another information resource management device connected with the network, the information resource corresponding to the identification information in an access request sent by the another information resource management device; an access history storage unit for storing at least information for identifying the another information resource management device and a history of the access including the identification information; and a storage processing unit for performing a predetermined process that stores the information resource into the storage device controlled by the another information resource management device, the predetermined process being performed under a predetermined condition that is determined based on the access history.

The identification information may include, for example, a number or a file name. When information resources stored in different storage devices have an identical content, these information resources may have an identical file name. When information resources having an identical content differ in file name for each storage device, an identical number may be attached to such files.

This configuration enables the accessed information resource management device to transfer the information from the storage device under its own control to the storage device under the control of another information resource management device, based on its own access history, and thereby reducing its own load autonomously. Furthermore, the information resource which another information resource management device desires to access is stored in the storage device under its own control, and thereby enabling the network load to be reduced and thus the access efficiency to be improved.

In the information resource management device of the present invention, the predetermined process may include migration or replication of the information resource. For example, the information resource which a plurality of devices have accessed may be subject to the replication while the information resource which a single device has accessed may be subject to the migration. This enables the information resource to be transferred to another storage device while the required information resource remains in the original storage device, and thereby improving the efficiency.

In the information resource management device of the present invention, the predetermined condition may include a condition that the frequency of access exceeds a predetermined value. The predetermined value may include, for example, ten accesses for three days. This enables the frequently accessed information resource to be stored into another storage device so as to disperse the load, and thereby improving the efficiency.

In the information resource management device, an access request reception unit further may receive user information for identifying a user who has sent an access request for the information resource via the another information resource management device, an access history management unit may manage an access history including the user information, and a storage processing unit may perform a predetermined process in response to a change of information resource management device used by the user.

This configuration enables the information resource to be stored into a suitable storage device according to the user's movement between physical locations, and thereby improving the efficiency. Furthermore, for example, when the user's movement is detected and the user has also accessed another information resource, the another information may be also stored into the suitable storage device, and thereby preferably improving the access efficiency.

The present invention is configured as a second configuration described in the following. The second configuration is characterized by an access history management device for integrally managing an entire access history for an information resource, the access history management device being connected with a same network as a plurality of storage devices for storing the information resource and a plurality of information resource management devices for managing a storage location of the information resource are connected with, wherein the information resource management device maintains an access history for the information resource stored in a pre-specified storage device, and the access history management device includes: a history acquisition unit for acquiring the access history at a predetermined timing from the plurality of information resource management devices, the access history including at least information for identifying a sender information resource management device that has sent an access request for the information resource and identification information for identifying the information resource, the identification information being assigned based on identity of content of the information resource; and an instruction sending unit for sending a change instruction to the information resource management device based on the access history, the change instruction being intended to change storage devices to store the information resource therein.

The instruction sending unit may send the acquisition instruction for the information resource to the information resource management device acquiring the information resource or send an instruction to the information resource management device sending the information resource, for example. Furthermore, the change instruction may include a migration instruction or a replication instruction.

This configuration enables the access history management device to integrally manage the access history for all information resources on the network and to send a change instruction for changing storage devices to store the information resource to each information resource management device based on the access history, and thereby reducing the load of information resource management devices and thus improving the efficiency.

In the access history management device of the present invention, the predetermined timing may include timing at predetermined intervals set in advance. The “timing at predetermined intervals” may include, for example, timing every 10 minutes, every six hours, and every day at midnight such as 12:00 when the network utilization is relatively lower. Furthermore, a number of information resource management devices subject to a single collection may be set to sequentially collect the access history at the predetermined intervals. For example, the collection performed at shorter intervals preferably enables the state of accesses to information resources to be preferable determined earlier while the collection performed at longer intervals enables the network load to be reduced.

Alternatively, the predetermined timing may include, for example, an arbitrary timing depending on the information resource management device. The “predetermined timing” may include, for example, timing at predetermined intervals such as every ten minutes, and timing for every access. This configuration preferably enables the access history management device to acquire the access history without collecting the access history.

In the access history management device of the present invention, the history acquisition unit may further acquire user information for identifying a user who has sent an access request for the information resource as a part of the access history, and the instruction sending unit may further send a change instruction to change storage devices at a time to store a plurality of information resources having accessed by a same user. This configuration preferably enables the storage device storing the information resources to be changed according to the user's movement. For example, in the case of the user having moved, an information resource having frequently used by the user before the movement is expected to be also used after the movement, and therefore the storage to store such information therein is also changed in the same manner as the information resource that has triggered the detection of the user′ movement, and thereby improving the efficiency.

In the access history management device, the change instruction sent by the instruction sending unit may further include information for identifying an information resource management device controlling the storage device having stored the information resource before the change. Since the access history allows the network distance, the congestion state of the network, the status of accesses to the information resource, and the like to be determined, the change instruction may be generated with taking into account those information, for example. This configuration ensures the flexible determination on a storage device from which the information resource is transferred, and thereby improving the efficiency. For example, the storage device before the change may have the shortest network distance from the storage device after the change. This preferably enables the network load to be reduced.

The present invention is not limited to the information resource management device and the access history management device described above, but may be configured as a computer system including such devices, a method of managing an information resource, and the like. In addition, the present invention may be configured as a variety of aspects such as a computer program for controlling the above-mentioned information resource management device, a storage medium storing the computer program therein, a data signal embodied in a carrier wave containing the computer program; and so on. The various additional elements described previously are applicable to each aspect.

When the present invention is configured as a computer program, a recording medium with such program recorded therein, or the like, such configuration may include an entire program for controlling the information resource management device and the access history management device, or only a part that realizes the functions according to the present invention. A variety of computer-readable recording media may be used as the recording medium, including as flexible disk, CD-ROM, DVD-ROM, punched card, print with barcodes or other codes printed thereon, and internal storage device (memory such as ROM and RAM) and external storage device of the computer.

### BRIEF DESCRIPTION OF THE DRAWINGS

FIG. 1 is a schematic that exemplifies a general structure of a system according to a first embodiment;

FIG. 2 is a schematic that exemplifies functional blocks of a control node according to the first embodiment;

FIG. 3 is a flowchart that illustrates an access process according to the first embodiment;

FIG. 4 is a schematic that exemplifies an access history according to the first embodiment;

FIG. 5 is a flowchart that illustrates a file transfer process according to the first embodiment;

FIG. 6 is a flowchart that illustrates a file migration/replication process according to the first embodiment;

FIG. 7 is a flowchart that illustrates a user accessed file detection process according to the first embodiment;

FIG. 8A and 8B are schematics that illustrate an update process of file location information according to the first embodiment;

FIG. 9 is a schematic that exemplifies a general structure of a system according to a second embodiment;

FIG. 10A and 10B are schematics that exemplify functional blocks of an access history manager according to the second embodiment.

FIG. 11 is a schematic that exemplifies an access history collection process according to the second embodiment;

FIG. 12 is a schematic that exemplifies the access history according to the second embodiment; and

FIG. 13 is a flowchart that illustrates a migration/replication process according to the second embodiment.

### DESCRIPTION OF THE PREFERRED EMBODIMENTS

Embodiments of the present invention are described in the following sequence.

A. First Embodiment
A1. General Description of System
A2. Functional Blocks
A3. Access Process
A4. Access History
A5. Migration/Replication Process
   A5(1). Migration/Replication Determination Process
   A5(2). User Accessed File Detection Process
   A5(3). File Location Information Update Process

B. Second Embodiment
B1. General Description of System
B2. Functional Blocks
B3. Access History Collection Process
B4. Migration/Replication Process

C. Modifications

### A. First Embodiment

### A1. General Description of System

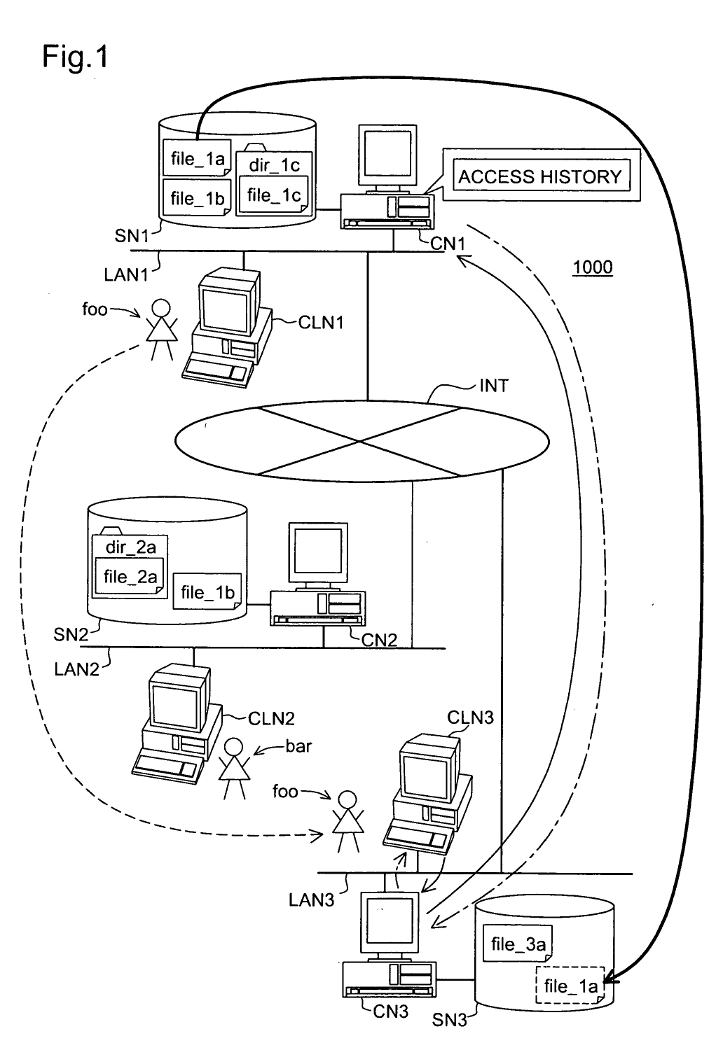

FIG. 1 is a schematic that exemplifies a general structure of a system according to a first embodiment. A computer system 1000 includes three local area networks LAN1, LAN2, and LAN3, which are connected with each other via the Internet INT. A control node CN1 and a client CLN1 are connected with the local area network LAN1, and a storage node SN1 is coupled with the control node CN1. As shown in FIG. 1, the storage node SN1 stores files “file_{—}1a” and “file_{—}1b,” and further stores a file “file_{—}1c” in a directory “dir_{—}1c.” The client CLN1 is used by a user “foo.” Similarly, control nodes CN2 and CN3, and clients CLN2 and CLN3 are connected with the local area networks LAN2 and LAN3 respectively, and storage nodes SN2 and SN3 are coupled with the control nodes CN2 and CN3 respectively. The storage node SN2 stores a file “file_{—}1b,” and further stores a file “file_{—}2a” in a directory “dir_{—}2a.” This file “file_{—}1b” is identical to the file “file_{—}1b” stored in the storage node SN1. The storage node SN3 stores a file “file_{—}3a.” Each of the control nodes controls accesses to the files stored in the corresponding storage node.

When the user “foo” desires to access one of the files stored in the storage node SN1, the user “foo” sends an access request to the control node CN1 and then receives the desired file via the control node CN1. When a user “bar” desires to access one of the files stored in the storage node SN1, the user “bar” sends an access request to the control node CN2 connected with the local area network LAN2, which the client CLN2 used by the user “bar” is also connected with. The control node CN2 determines that the access-requested file is stored in the storage node SN1, and then sends an access request to the control node CN1 controlling the storage node SN1. In this manner, according to this embodiment, the access request is sent to the control node CN1 controlling the storage node SN1 in order to access the file stored in the storage node SN1. Furthermore, the control node CN1 manages an access history for accesses via the control node CN1 to the files stored in the storage node SN1 as shown in FIG. 1. Similarly, the control nodes CN2 and CN3 also manage an access history for accesses to the files stored in the storage nodes SN2 and SN3 respectively.

Now, the user “foo,” who once used the client CLN1, moves to the client CLN3 connected with the local area network LAN3, and then sends an access request for the file “file_{—}1a” stored in the storage node SN1 via the control node CN3 to the control node CN1 as shown by the solid line arrow in FIG. 1. The control node CN1 transfers the file “file_{—}1a” via the control node CN3 to the client CLN3 as shown by the dashed line arrow. Whenever the control node CN3 accesses the file “file_{—}1a”, a record of the access is accumulated in the access history. If the control node CN1 refers to the access history and detects the frequent accesses from the control node CN3, it determines whether or not a device other than the control node CN3 have accessed the file “file_{—}1a” and then replicates or migrates the file “file_{—}1a” to the storage node SN3 controlled by the control node CN3 as shown by the bold line arrow. The replication is performed if another device has accessed the file. Otherwise the migration is performed.

### A2. Functional Blocks

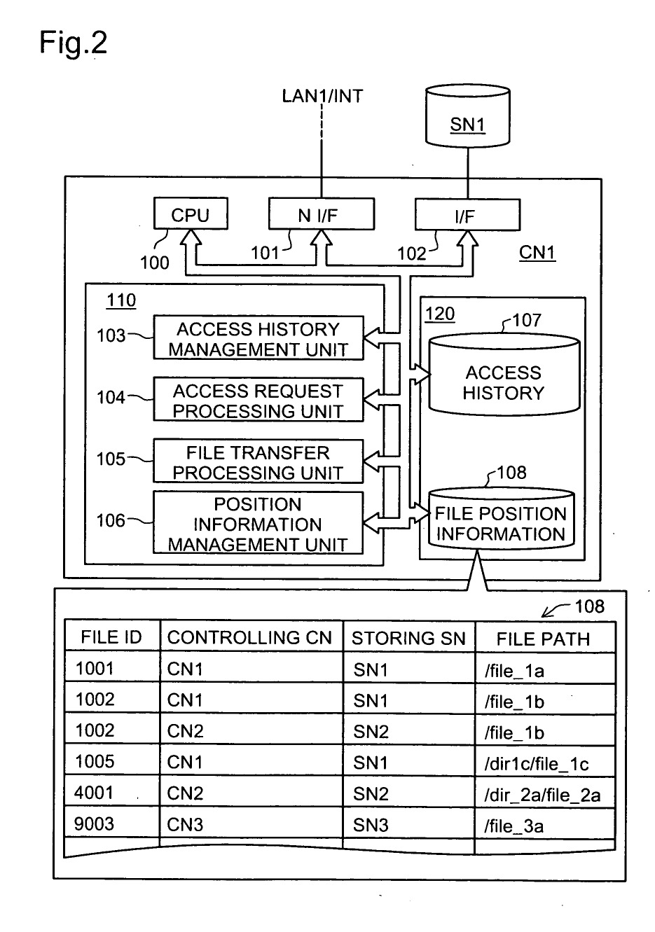

FIG. 2 is a schematic that exemplifies functional blocks of the control node CN1 according to this embodiment. The control node CN1 is configured as a microcomputer that includes a CPU 100, a network interface 101, a storage interface 102, and a ROM 110. The ROM 110 includes an access history management unit 103, an access request processing unit 104, a file transfer processing unit 105, and a location information management unit 106 as functional blocks that perform the respective functions. A hard disk 120 included in the control node CN1 stores an access history 107 that stores a record of access request to the control node CN1, and file location information 108 that indicate which storage node stores a particular file. The control node CN1 is controlled by the CPU 100.

The network interface 101 has a function of communicating with the local area network LAN1 or Internet INT. The storage interface 102 has a function of communicating with the storage node SN1. The access history management unit 103 stores a record of access to the storage node SN1 from another device in the access history 107. The access history 107 will be described later in detail.

When the access request processing unit 104 receives an access request from another device, it refers to the file location information 108 to identify a storage node storing the requested file therein. If the requested file is stored in the storage node SN1 controlled by the control node CN1, the access request processing unit 104 acquires the file from the storage node SN1 and then sends it to the requester device. If the requested file is stored in another storage node, the access request processing unit 104 sends an access request whose requester is the control node CN1 to a control node controlling such storage node.

If the file transfer processing unit 105 refers to the access history 107 and detects the frequent accesses from a particular control node to a particular file, it transfers this file to a storage node controlled by such control node. Such transfer includes two types of methods, migration and replication. If a control node other than such control node has also accessed the particular file, the replication is performed. Otherwise, the migration is performed.

The location information management unit 106 updates the file location information 108, when the file transfer processing unit 105 has transferred the file. The file location information 108 of the location information management unit 106 is also updated in response to update in the other location information management unit 106 in the other control node CN through receiving information regarding the update. FIG. 2 also shows the details of the file location information 108. The file location information 108 include file IDs, controlling CNs, storing SNs, and file paths. The file ID is a number attached to one or more file based on identity of file, and the storing SN indicates a storage node storing the file therein. The controlling CN indicates a control node controlling each storage node, and the file path indicates a location of the file under the control of the storing storage node. For example, files with the file ID “1002” have an identical content, and are stored in the storage node SN1 and in the storage node SN2 respectively. In this embodiment, the files with the file ID “1002” have an identical file name “file_{—}1b” as indicated by the file paths, but may have different file names. The file path “/dir_{—}2a/file_{—}1c” of the file ID “1005” indicates that the file “file_{—}1c” is stored in the directory “dir_{—}2a.”

### A3. Access Process

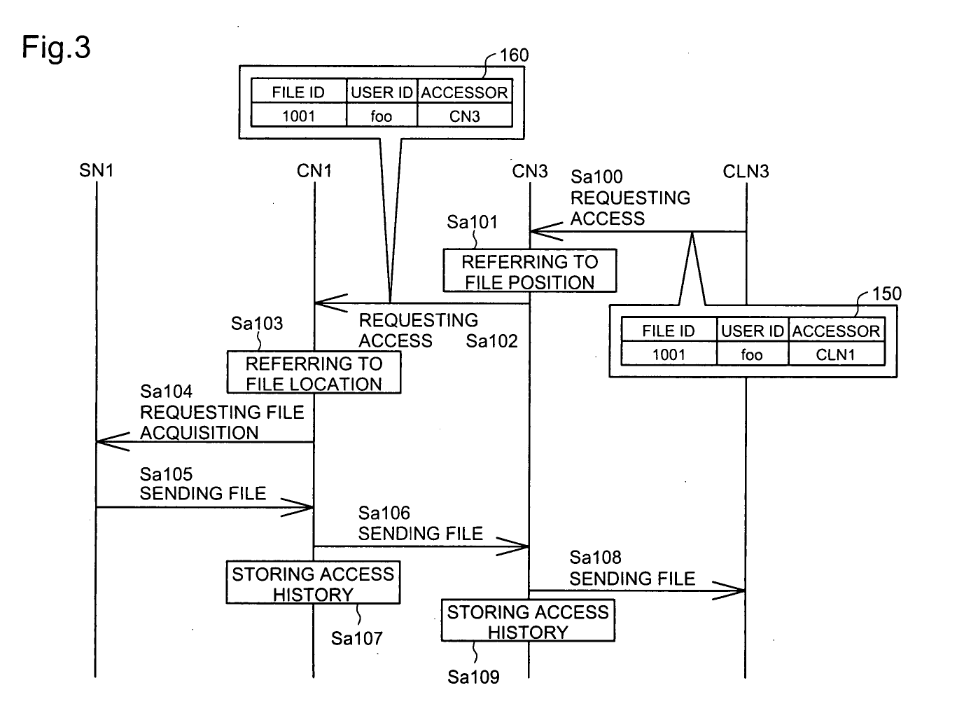

FIG. 3 is a flowchart that illustrates an access process according to this embodiment. FIG. 3 exemplifies how the client CLN3 accesses the file with file ID “1001” stored in the storage node SN1.

The client CLN3 sends an access request 150 to the control node CN3 of the local area network LAN3 which the client CLN3 is connected with (step Sa100). The access request 150 includes the file ID “1001” of the requested file, the user “foo” who has sent the access request, and the “CLN3” that is an accessor. The user “foo” has logged on the client CLN3.

When the control node CN3 receives the access request 150, it refers to the file location information 108 to acquire the information on the storage node storing the file with such file ID “1001” and on the control node controlling such storage node (step Sa101). Since the file ID “1001” is stored in the storage node SN1 and managed by the control node CN1, the control node CN3 sends an access request 160 to the control node CN1 (step Sa102). The access request 160 includes the file ID “1001” of the requested file, the user “foo” who has sent the access request, and the “CN3” that is an accessor. Since the access request 160 is sent by the control node CN3, the accessor is the control node CN3.

When the control node CN1 receives the access request 160, it refers to the file location information 108 to acquire the information on the storage node storing the file with such file ID “1001” and on the control node controlling such storage node (step Sa103). Since the file ID “1001” is stored in the storage node SN1 and managed by the control node CN1 itself, the control node CN1 sends the acquisition request for the file ID “1001” to the storage node SN1 (step Sa104).

The storage node SN1 receives the acquisition request for the file, and then transfers the file with the file ID “1001” to the control node CN1 (step Sa105).

The control node CN1 receives the file from the storage node SN1, sends it to the control node CN3 of accessor (step Sa106), and updates the access history (step Sa107).

The control node CN3 receives the file from the control node CN1, sends it to the client CLN3 of access requester device (step Sa108), and updates the access history (step Sa109).

### A4. Access History

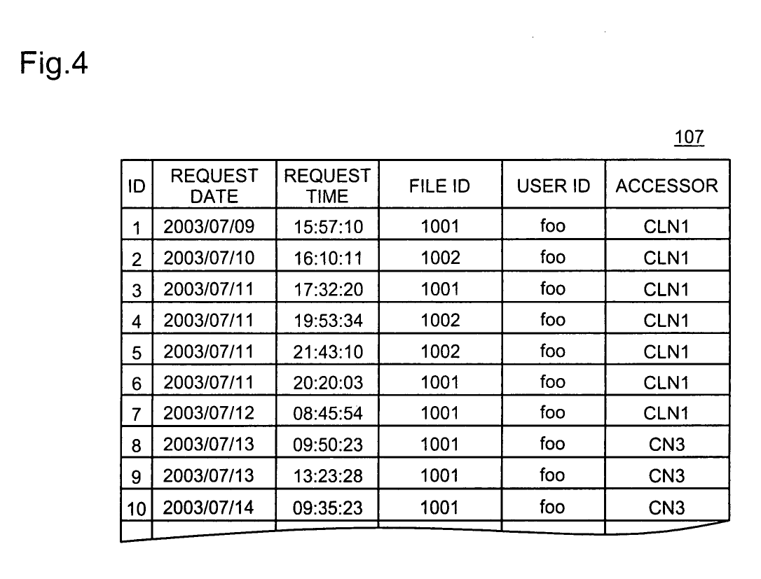

FIG. 4 is a schematic that exemplifies an access history 107 according to this embodiment. The access history 107 includes six items of ID, request date, request time, file ID, user ID, and accessor. The “ID” denotes an unique number given to each record in the access history, and the “request date” and the “request time” denote date and time when an access request was received. The file ID, the user ID, and the accessor reflect the contents of the access requests 150 and 160 described with reference to FIG. 3. For example, the ID “3” indicates that the access request was received at “17:32:20 on Jul. 11, 2003” and that the access request was sent by the user “foo” using the client CLN1 for the file ID “1001.” In addition, the IDs “1” through “7” indicate that the user “foo” accessed the file ID “1001” or “1002” from the client CLN1, and the IDs “8” through “10” indicate that the user “foo” accessed the file ID “1001” via the control node CN3. This means that the user ID “foo” moved from the client CLN1 to the client CLN3.

### A5. Migration/Replication Process

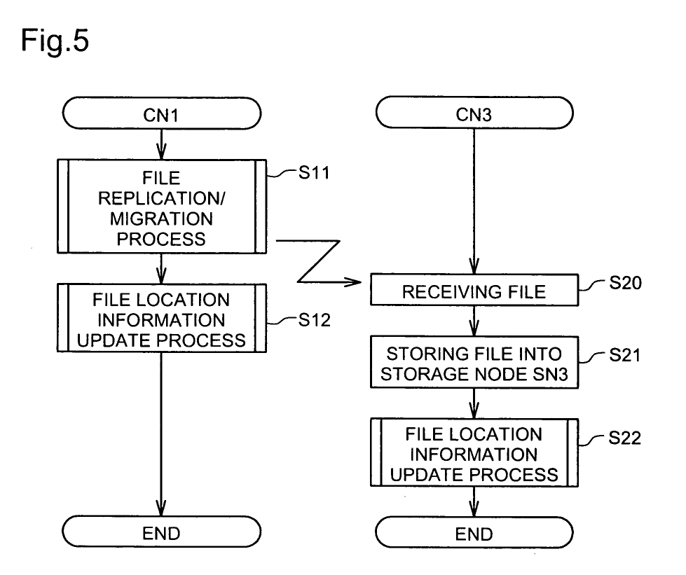

FIG. 5 is a flowchart that exemplifies a file transfer process according to this embodiment. The process is performed by transferring information between the control node CN1 and the control node CN3.

When the control node CN1 refers to the access history, and detects the frequent accesses to a predetermined file via the control node CN3, then it performs the migration or replication process on the file (step S11). Such process will be described later. Since the file migration or replication process causes the storing storage node of the file to be changed, the control node CN1 updates the file location information 108 (step S12).

When the control node CN3 receives the file through the migration or replication process performed by the control node CN1 (step S20), it stores the received file into the storage node SN3 controlled by the control node CN3 (step S21), and then updates the file location information 108 (step S22). After the completion of the migration/replication process, one of destination and source control node CNs of the migration/replication process transmits the information regarding to the update of the file location information, to the other control node CN (in this case, for example, CN2) that has not directly related to the process, thereby causing the other control node CN to update its file location information.

### A5(1). Migration/Replication Determination Process

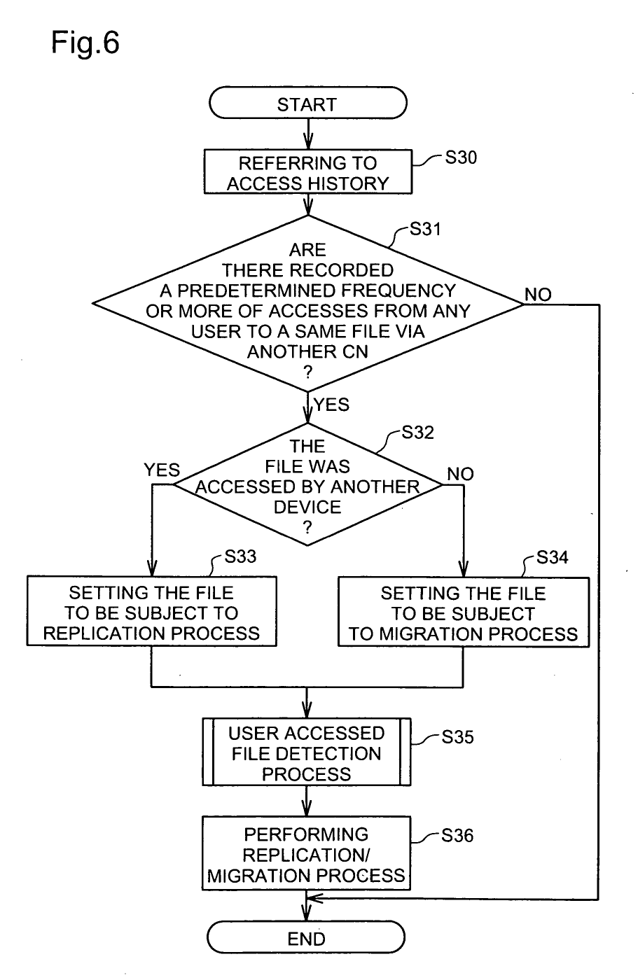

FIG. 6 is a flowchart that illustrates the file migration/replication process according to this embodiment. The process begins with the step that the file transfer processing unit 105 of the control node CN1 refers to the access history 107, and corresponds to step S10.

The control node CN1 refers to the access history (step S30), and determines whether or not there are recorded a predetermined frequency or more of accesses from any user to a same file (step S31). In this embodiment, the predetermined frequency or more of accesses represent three or more accesses for three days. If the predetermined frequency or more of accesses are not recorded (i.e. NO at step S31), the process is exited.

On the contrary, if the predetermined frequency or more of accesses are recorded (i.e. YES at step S31), the control node CN1 determines whether or not the file having undergone such accesses was accessed by another device (step S32). If the file was accessed by another device (i.e. YES at step S32), the file is set to be subject to the replication process (step S33) since the file must be retained in the storage node SN1. If the file was not accessed by another device (i.e. NO at step S32), such file is set to be subject to the migration process (step S34).

In this embodiment, the IDs “8” through “10” indicate that the user ID “foo” accessed the file ID “1001” three times for two days from Jul. 13, 2003 to Jul. 14, 2003 and that no access was performed by another device, as shown in FIG. 4. Therefore the file ID “1001” is set to be subject to the migration process.

Next, if this user accessed any file other than the above file, the control node CN1 also sets such files to be subject to the replication or migration process (step S35). Such process will be described later.

Then, the control node CN1 performs the replication/migration on the files that are subject to the replication or migration process (step S36).

### A5(2). UserAccessed File Detection Process

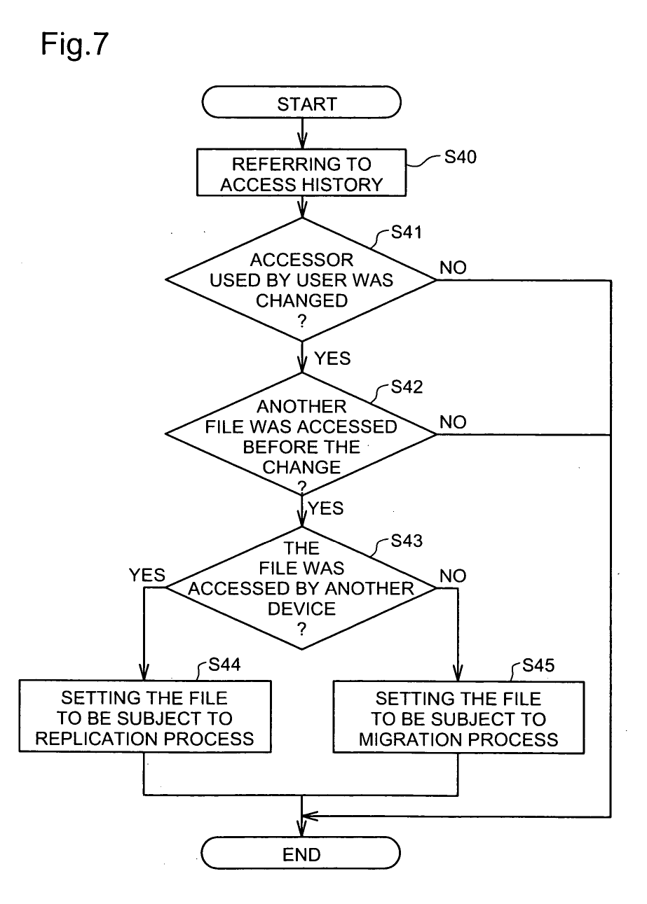

FIG. 7 is a flowchart that illustrates a user accessed file detection process according to this embodiment. This process corresponds to step S35 shown in FIG. 6.

The control node CN1 refers to the access history (step S40) to determine whether or not the accessor used by the user was changed (step S41). Specifically, if the access history 107 indicates that the accesses were performed with the user ID identical and the accessor changed, for example, the accessor was changed from the client CLN1 to the control node CN3, the control node CN1 determines that the user moved from the client CLN1 to the client CLN3 connected with the local area network LAN3.

If the accessor was not changed (i.e. NO at step S41), the process is exited. On the contrary, if the accessor was changed (i.e. YES at step S41), the control node CN1 determines based on the access history 107 where or not another file was accessed before the change of accessor (step S42). If another file was not accessed (i.e. NO at step S42), the process is exited.

On the contrary, if another file was accessed before the change of accessor (i.e. YES at step S42), the control node CN1 determines whether or not such file was accessed by another device (step S43). If the file was accessed by another device (i.e. YES at step S43), it is set to be subject to the replication process (step S44) since it must be retained in the storage node SN1. If the file was not accessed by another device (i.e. NO at step S43), the file is set to be subject to the migration process (step S45).

In this embodiment, since the user ID “foo” accessed the file ID “1002” before the change of accessor and no access was performed by another device, the file ID “1002” is also set to be subject to the migration process.

### A5(3). File Location Information Update Process

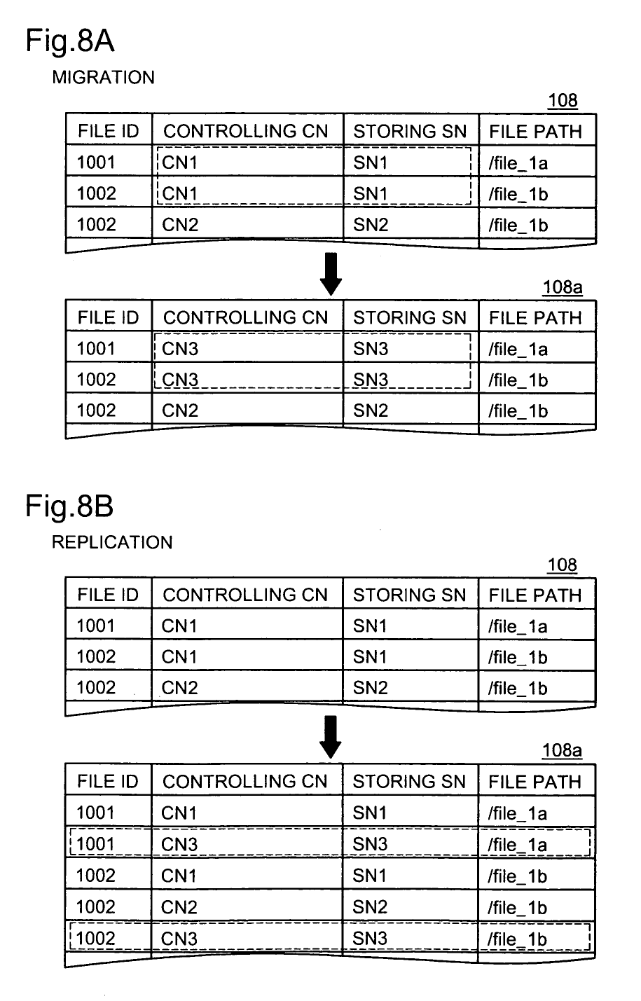

FIG. 8 is a schematic that illustrates an update process of the file location information 108 according to this embodiment. This process corresponds to steps S12 and S22 shown in FIG. 5.

FIG. 8A shows how the file location information 108 is updated when the file is transferred through the migration process. This process is performed by the location information management unit 106 of the control node CN1.

The file location information 108 include the information before the migration process while the file location information 108a include the information after the migration process. After the migration process, the location information management unit 106 changes the controlling CN and the storing SN of the file IDs “1001” and “1002” from “CN1” to “CN3” and from “SN1” to “SN3” respectively as shown by the broken line in the file location information 108a.

FIG. 8B shows how the file location information 108 are updated when the file is transferred through the replication process. In this embodiment, the file IDs “1001” and “1002” are migrated, but it is assumed that both the files are transferred through the replication process in FIG. 8B.

The file location information 108 include the information before the replication process while the file location information 108b include the information after the replication process. After the replication process, the location information management unit 106 adds records of the file IDs “1001” and “1002,” and then sets “CN3” as the controlling CN and “SN3” as the storing SN as shown by the broken line in the file location information 108b. After the completion of the process in FIG. 5, either of the control node CN1 and CN3 transmits the information regarding to the update of the file location information, to the other control node CN that has not directly related to the process (in this case, for example, CN2), thereby causing the other control node CN to update its file location information. This update process in the other control node CN is similar to the process in FIG. 8.

The control node CN1 according to the first embodiment described above enables the destination of file migration or replication to be specified based on the information on access frequencies and accessors obtained from the access history. That is, the accessed control node can perform the file transfer in consideration of the state of load to autonomously reduce its load, and thereby reducing the file transfers on the network and thus improving the efficiency.

### B. Second Embodiment

In the first embodiment, the control node manages the access history for accesses to itself, and performs the file migration or replication process based on the access history. In a second embodiment, an access history manager is provided that integrally manages an access history for all accesses to control nodes on the network and instructs a control node to acquire a file based on the access history.

### B1. General Description of System

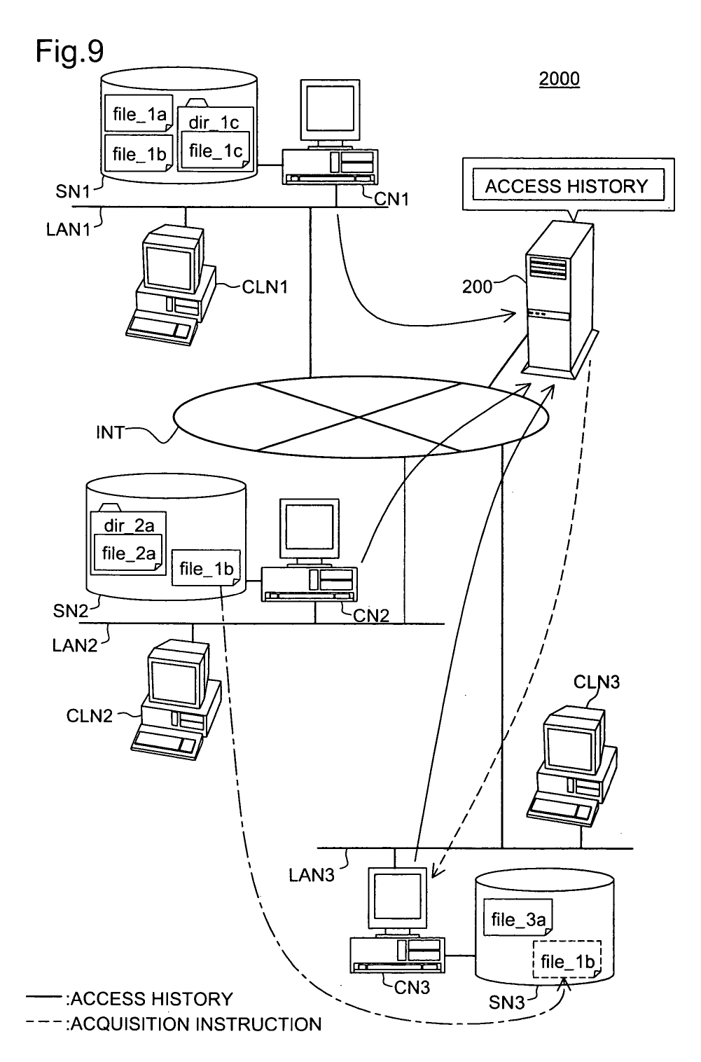

FIG. 9 is a schematic that exemplifies a general structure of a system according to the second embodiment. A computer system 2000 includes three local area networks LAN1, LAN2, and LAN3, and the access history manager 200, which are connected with each other via Internet INT. The control nodes CN1 through CN3 and the clients CLN1 through CLN3 respectively connected with the local area networks LAN1 through LAN3, and the storage nodes SN1 through SN3 coupled with the respective control nodes are configured in the same manner as the first embodiment, and will not be described further.

Each of the control nodes manages the access history for files stored in the corresponding storage node, and the access history manager 200 collects and integrally manages such access histories as shown by the solid line in FIG. 9. The access history collection process will be described later. When the access history manager 200 refers to the access history and detects the frequent accesses from the control node CN3 to the file “file_{—}1b,” then it sends the acquisition instruction for the file “file_{—}1b” to the control node CN3 as shown by the broken line arrow in FIG. 9. When the control node CN3 receives the instruction, it refers to the file location information 108 to acquire the file “file_{—}1b” from the storage node SN2 that stores the file “file_{—}1b” and has the shortest network distance from the control node CN3 as shown by the dashed line arrow. Such file acquisition process will be described later.

### B2. Functional Blocks

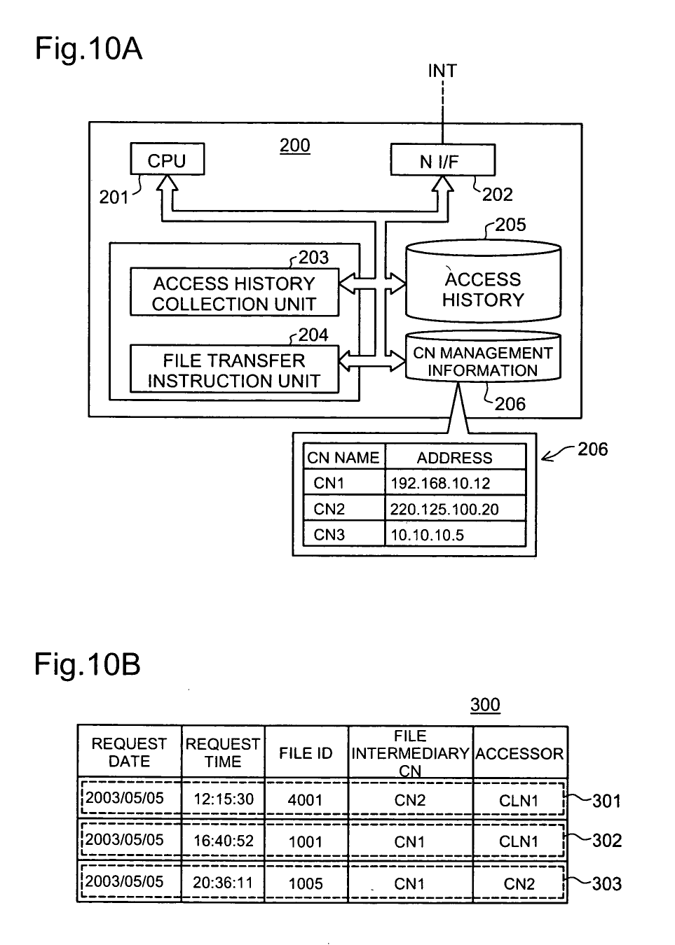

FIG. 10A is a schematic that exemplifies functional blocks of the access history manager 200 according to this embodiment. The access history manager 200 is configured as a microcomputer that includes a CPU 201, a network interface 202, and a ROM 210. The ROM 210 includes an access history collection unit 203, and a file transfer instruction unit 204 as functional blocks that perform the respective functions. Furthermore, a hard disk 220 included in the access history manager 200 stores the access history 205 having collected from each of the control nodes, and CN management information 206 for managing the control nodes. The access history manager 200 is controlled by the CPU 201.

The access history collection unit 203 collects the access history of each of the control nodes at predetermined intervals, and then stores them into the access history 205. The file transfer instruction unit 204 sends an instruction for transferring a file based on the access history 205 and the CN management information 206.

FIG. 10A also shows the details of the CN management information 206. The CN management information 206 include CN names, and addresses. The “CN name” denotes a name of control node, and the “address” denotes an IP address of control node. For example, the IP address of the control node CN1 is “192.168.10.12.“

FIG. 10B shows an exemplary access history 300 that the access history manager 200 has collected from the control node CN1. The access history 300 includes request date, request time, file IDs, file intermediary CNs, and accessors. The “request date” and the “request time” denote date and time when an access request was received. The accessor denotes a client or control node as access requester, and the file intermediary CN denotes a control node that controls a storage node storing the access-requested file. For example, the access record 301 boxed by the broken line indicates that the client CLN1 sent an access request for the file ID “4001” to the control node CN1, and then the control node CN1 sent an access request to the control node CN2, which controls the storage node SN2 storing the file of the file ID “4001,” to acquire the file. Since the records 302 and 303 in the access history 300 represent access requests for the files that are stored in the storage node SN1 controlled by the control node CN1, the control node CN1 itself is a file intermediary CN.

### B3. Access History Collection Process

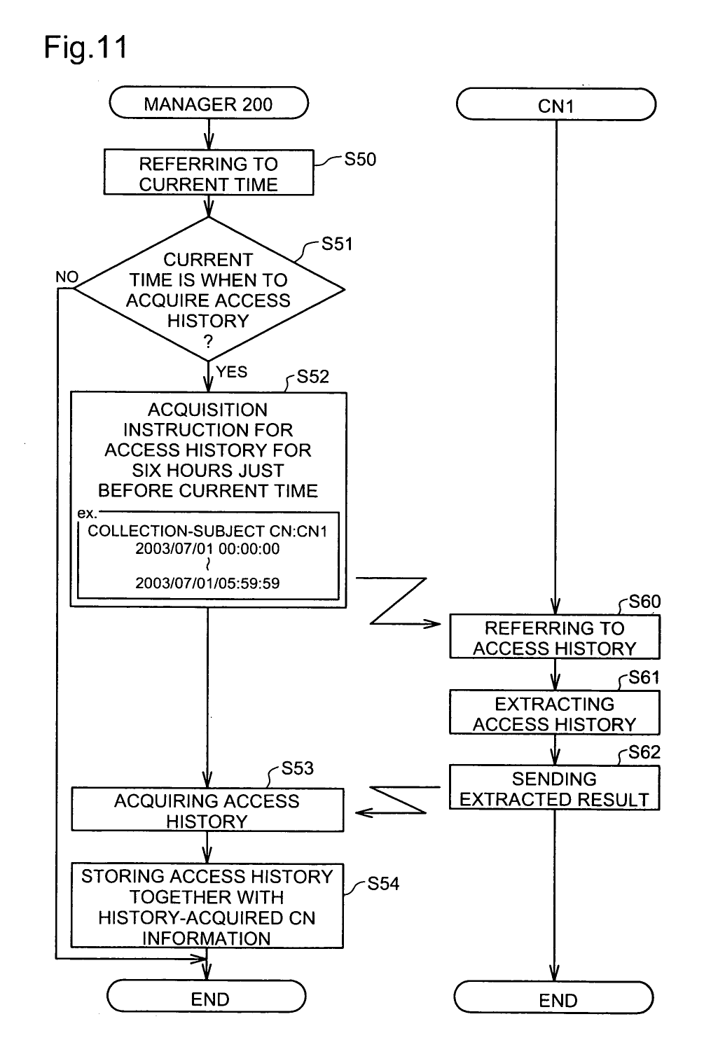

FIG. 11 is a schematic that exemplifies the access history collection process according to this embodiment. The process is performed by transferring information between the access history manager 200 and each of the control nodes. In this embodiment, the process performed between the access history manager 200 and the control node CN1 is shown for sake of efficiency of explanation.

The access history manager 200 refers to current time (step S50) to determine whether or not the current time is when to acquire the access history (step S51). In this embodiment, the access history is acquired every six hours. If the current time is not when to acquire the access history (i.e. NO at step S51), the process is exited.

If the current time is when to acquire the access history (i.e. YES at step S51), the access history manager 200 sends to the control node CN1 the acquisition instruction for the access history for six hours just before the current time (step S52). For example, when the access history is acquired at 0:00, 6:00, 12:00, and 18:00 every day, and the current date is Jul. 1, 2003, the acquisition instruction sent at 6:00 to acquire the access history is intended to acquire the access history that was recorded “from Jul. 01, 2003 00:00:00 to Jul. 07, 2003 05:59:59.”

When the control node CN1 receives such instruction, it refers to its own access history (step S60) to extract an access history having been recorded for the specified period (step S61). Next, the control node CN1 sends the extracted access history to the access history manager 200 (step S62).

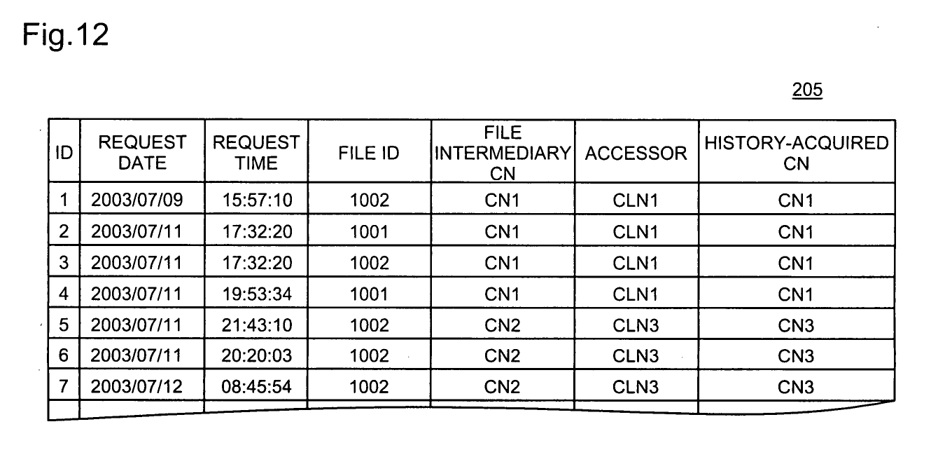

The access history manager 200 acquires the access history from the control node CN1 (step S53), and then stores it together with the information on the history-acquired control node to the access history 205 (step S54). FIG. 12 shows the access history having collected in this manner.

FIG. 12 is a schematic that exemplifies the access history 205 according to this embodiment. The access history 205 includes seven items of ID, request date, request time, file ID, file intermediary CN, accessor, and history-acquired CN. The “ID” denotes an unique number given to each record in the access history, and the “request date” and the “request time” denote date and time when an access request was received. The file ID, the file intermediary CN, and the accessor reflect the contents of the access history 300 shown in FIG. 10B. The history-acquired CN denotes a control node from which an access history was acquired. For example, the record of ID “3” in the access history 205 indicates that it was acquired from the control node CN1, and that the client CLN1 accessed the file ID “1002” at “17:32:20 on Jul. 11, 2003,” and then received the file via the control nod CN1.

The records of IDs “5” through “7” in the access history 205 indicate that they were collected from the control node CN3, and that the client CLN3 frequently sent the access request for the file ID “1002” via the control node CN2.

### B4. Migration/Replication Process

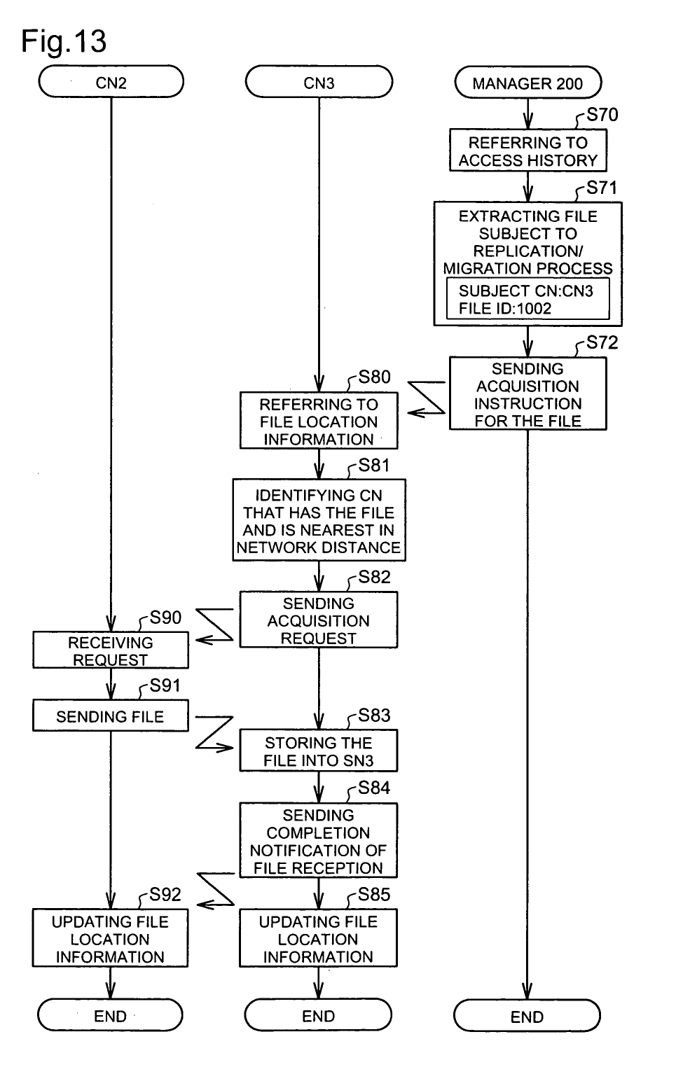

FIG. 13 is a flowchart that illustrates the migration/replication process according to this embodiment. The access history manager 200 detects the client CLN3 having frequently sent the access request for the file ID “1002” via the control node CN2 as described with reference to FIG. 12, and then sends an acquisition instruction for the file to the control node CN3. In this embodiment, the control node CN2 is closer to the control node CN3 in network distance than the control node CN1.

When the access history manager 200 refers to the access history 205 (step S70) and detects the client CLN3 having frequently sent the access request for the file ID “1002” via the control node CN2 as described with reference to FIG. 12, it sets the file ID “1002” to be subject to the migration or replication process so as to transfer the file to the control node CN3 (step S71). Next, the access history manager 200 sends the acquisition instruction for the file ID “1002” to the control node CN3 (step S72).

When the control node CN3 receives the acquisition instruction, it refers to the file location information 108 to identify the storage node storing the file ID “1002” (step S80). In this embodiment, the file with the file ID “1002” is stored both in the storage nodes SN1 and SN2. Next, the control node CN1 identifies a control node CN whose storage node stores the file ID “1002” and has the shortest network distance from the control node CN3 (step S81). In this embodiment, such control node is the control node CN2. The control node CN3 sends an acquisition instruction for the file of the file ID “1002” to the control node CN2 (step S82).

When the control node CN2 receives the acquisition instruction from the control node CN3 (step S90), it determines whether or not the file was accessed by another device, and then sends the file of the file ID “1002” through the migration or replication process (step S91).

When the control node CN3 receives the file from the control node CN2, it stores the file into the storage node SN3 (step S83) and then sends a completion notification of the file reception (step S84). Next, the control node CN3 updates the file location information (step S85).

The control node CN2 receives the completion notification of the file reception from the control node CN3 and then updates the file location information (step S92). After the completion of the migration/replication process, one of destination and source control node CNs of the migration/replication process transmits the information regarding to the update of the file location information, to the other control node CN that has not directly related to the process, thereby causing the other control node CN to update its file location information.

Although the user ID is not included in the access history in this embodiment, the access history may be managed including the user ID. This enables a file transfer instruction to be made in consideration of the user's movement, and thereby improving the efficiency. For example, if the user accessed the files of the file IDs “1001” and “1002” from the client CLN1 via the control node CN1 before the movement, and repeatedly accessed the file ID “1002” after the movement to the client CLN3, the access history manager 200 determines based on the access history that the user also accessed the file ID “1001” before the movement, and thus instructs the control node CN3 to acquire both the files of the file IDs “1001” and “1002.” The file ID “1002” and the file ID “1001” may be acquired from the control nodes CN2 and CN1 respectively, and otherwise they may be acquired together from the control node CN1 that can supply both the files.

Although the access history manager 200 collects the access history from each of the control nodes at predetermined intervals in this embodiment, the present invention is not limited to this. The control nodes may send their access history to the access history manager 200 in an arbitrary timing. The arbitrary timing may include a variety of timing such as a time point when the access history is generated, every hour, and the like.

Although the access history manager 200 instructs the file acquiring control node to transfer the file in this embodiment, it may instruct the file sending control node to transfer the file. Alternatively, the access history manager 200 may send to the file acquiring control node the acquisition instruction that also informs about which control node the file is to be acquired from.

### C. Modifications

Although the various embodiments of the present invention have been described, the present invention is not limited to these embodiments and may include various configurations without departing from the spirit of the present invention.

1. An information resource management device being provided in associated with a storage device and managing an information resource stored in the storage device, wherein a plurality of said storage devices and a plurality of said information resource management devices are connected with a network, said information resource management device comprising:
a storage information management unit for managing storage information that indicate which storage device stores said information resource in associated with identification information assigned based on identity of content of said information resource;
a sending unit for sending said information resource back to another information resource management device connected with said network, said information resource corresponding to said identification information in an access request sent by said another information resource management device;
an access history storage unit for storing at least information for identifying said another information resource management device and an access history for said access including said identification information; and
a storage processing unit for performing a predetermined process that stores said information resource into a storage device controlled by said another information resource management device, said predetermined process being performed under a predetermined condition that is determined based on said access history.

2. An information resource management device according to claim 1, wherein said predetermined process includes migration or replication of said information resource.

3. An information resource management device according to claim 1, wherein said predetermined condition includes a condition that the frequency of said access exceeds a predetermined value.

4. An information resource management device according to claim 1, wherein
an access request reception unit further receives user information for identifying a user who has sent access request for said information resource via said another information resource management device,
said access history management unit manages an access history including said user information, and
said storage processing unit performs said predetermined process in response to a change of information resource management device used by said user.

5. An access history management device for integrally managing an entire access history for an information resource, said access history management device being connected with a same network as a plurality of storage devices for storing said information resource and a plurality of information resource management devices for managing a storage location of said information resource are connected with, wherein said information resource management device maintains an access history for said information resource stored in a pre-specified storage device, said access history management device comprises:
a collection unit for collecting said access history at a predetermined timing from said plurality of information resource management devices, said access history including at least information for identifying a sender information resource management device that has sent an access request for said information resource and identification information for identifying the information resource, said identification information being assigned based on identity of content of said information resource; and
an instruction sending unit for sending a change instruction to said information resource management device based on said access history, said change instruction being intended to change storage devices to store said information resource therein.

6. An access history management device according to claim 5, wherein said predetermined timing includes timing at predetermined intervals set in advance.

7. An access history management device according to claim 5, wherein said predetermined timing includes an arbitrary timing depending on said information resource management device.

8. An access history management device according to claim 5, wherein
said collection unit further collects user information for identifying a user who has sent an access request for said information resource as a part of said access history,
said instruction sending unit further sends a change instruction to change storage devices at a time to store a plurality of information resources having accessed by a same user.

9. An access history management device according to claim 5, wherein said change instruction sent by said instruction sending unit further includes information for identifying an information resource management device controlling said storage device having stored said information resource before the change.

10. An access history management device according to claim 9, wherein said storage device before the change has the shortest network distance from said storage device after the change.

11. A computer system including a plurality of storage devices for storing an information resource and a plurality of information resource management devices for managing said information resource among said plurality of storage devices connected with a network, wherein
a first information resource management device is provided in associated with a storage device and stores an access history for said information resource stored in the storage device,
said first information resource management device sends said information resource to a second information resource management device under a predetermined condition that is set based on said access history, and
said second information resource management device receives said information resource sent from said first information resource management device and then stores said information resource into a storage device pre-specified to be under the control of said second information resource management device.

12. A computer system including a plurality of storage devices for storing an information resource, a plurality of information resource management devices for managing said information resource among said plurality of storage devices, and an access history management device for managing an access history for all information resources connected with a network, wherein
each information resource management device maintains an access history for said information resource stored in a storage device pre-specified among said plurality of storage devices,
said access history management device collects said access history from said each information resource management device,
said access history management device sends a change instruction to said information resource management device based on the access history, said change instruction being intended to change storage devices to store said information resource therein, and
said information resource management device having received said change instruction changes storage devices to store said information resource.

13. A method of managing an information resource by means of an information resource management device being provided in associated with a storage device and managing said information resource stored in the storage device, wherein a plurality of said storage devices and a plurality of said information resource management devices are connected with a network, said method comprising steps of:
(a) managing storage information that indicate which storage device stores said information resource in associated with identification information assigned based on identity of content of said information resource;
(b) sending said information resource back to another information resource management device connected with said network, said information resource corresponding to said identification information in an access request sent by said another information resource management device;
(c) storing at least information for identifying said another information resource management device and an access history for said access including said identification information; and
(d) performing a predetermined process that stores said information resource into a storage device controlled by said another information resource management device, said predetermined process being performed under a predetermined condition that is determined based on said access history.

14. A method of managing an information resource based on an entire access history for said information resource stored in a plurality of storage devices, wherein a plurality of information resource management devices for managing a storage device to store said information resource maintain an access history for said information resources stored in a pre-specified storage device, said method comprising steps of:
(a) collecting said access history at a predetermined timing from said plurality of information resource management devices, said access history including at least information for identifying a sender information resource management device that has sent an access request for said information resource and identification information for identifying the information resource, said identification information being assigned based on identity of content of said information resource; and
(b) sending a change instruction to said information resource management device based on said access history, said change instruction being intended to change storage devices to store said information resource.

15. A method of managing an information resource in a computer system including a plurality of storage devices for storing said information resource and a plurality of information resource management devices for managing said information resource among said plurality of storage devices connected with a network, the method comprising steps of:
(a) causing a first information resource management device to store an access history for said information resource stored in a pre-specified storage device,
(b) causing said first information resource management device to send said information resource to a second information resource management device under a predetermined condition that is set based on said access history, and
(c) causing said second information resource management device to receive said information resource sent from said first information resource management device and then store said information resource into a storage device pre-specified to be under the control of said second information resource management device.

16. A method of managing an information resource in a computer system including a plurality of storage devices for storing said information resource, a plurality of information resource management devices for managing said information resource among said plurality of storage devices, and an access history management device for managing an access history for all information resources connected with a network, said method comprising steps of:
(a) causing each information resource management device to maintain an access history for said information resource stored in a storage device pre-specified among said plurality of storage devices;
(b) causing said access history management device to collect said access history from said each information resource management device;
(c) sending a change instruction to said information resource management device based on the access history, said change instruction being intended to change storage devices to store said information resource therein, and
(d) causing said information resource management device having received said change instruction to change storage devices to store said information resource therein.

17. A computer readable medium in which a computer program is recorded, the computer program for causing a computer to manage an information resource by means of an information resource management device being provided in associated with a storage device and managing said information resource stored in the storage device, said computer program causing said computer to implement functions of:
managing storage information that indicate which storage device stores said information resource in associated with identification information assigned based on identity of content of said information resource;
sending said information resource back to another device connected with said network, said information resource corresponding to said identification information in an access request sent by said another device;
storing at least information for identifying said another device and an access history for said access including said identification information; and
performing a predetermined process that stores said information resource into a storage device controlled by said another device, said predetermined process being performed under a predetermined condition that is determined based on said access history.

18. A computer readable medium in which a computer program is recorded, the computer program for causing a computer to manage an information resource based on an entire access history for said information resource stored in a plurality of storage devices, wherein a plurality of information resource management devices for managing a storage device to store said information resource maintain an access history for said information resource stored in a pre-specified storage device, said computer program causing said computer to implement functions of:
collecting said access history at a predetermined timing from said plurality of information resource management devices, said access history including at least information for identifying a sender information resource management device that has sent an access request for said information resource and identification information for identifying the information resource, said identification information being assigned based on identity of content of said information resource; and
sending a change instruction to said information resource management device based on said access history, said change instruction being intended to change storage devices to store said information resource therein.
